(19) United States
(12) Patent Application Publication
(10) Pub. No.: US 2022/0416376 A1
(43) Pub. Date: Dec. 29, 2022

(54) BATTERY

(71) Applicant: Panasonic Intellectual Property Management Co., Ltd, Osaka (JP)

(72) Inventors: KAZUHIRO MORIOKA, Osaka (JP); AKIRA KAWASE, Osaka (JP)

(21) Appl. No.: 17/901,870

(22) Filed: Sep. 2, 2022

Related U.S. Application Data
(63) Continuation of application No. PCT/JP2021/002512, filed on Jan. 25, 2021.

(30) Foreign Application Priority Data
Mar. 25, 2020 (JP) 2020-054859

(51) Int. Cl. H01M 50/564; H01M 50/528; H01M 10/0585

(52) U.S. Cl. CPC H01M 50/564; H01M 50/528; H01M 10/0585; H01M 10/0562

(57) ABSTRACT

A battery according to the present disclosure includes: a power generating element including a first electrode, a second electrode, and an electrolyte layer between the first electrode and the second electrode; and a first extraction electrode. The first electrode includes a first current collector and a first active material layer between the first current collector and the electrolyte layer. The first extraction electrode includes: a first conductive member connected to a first surface of the first current collector, the first surface being opposite to the first active material layer; and a first lead connected to the first conductive member.

### BACKGROUND

### 1. Technical Field

The present disclosure relates to a battery.

### 2. Description of the Related Art

Japanese Unexamined Patent Application Publication No. 2010-140703 and WO 2018/025649 each disclose a battery including a current collector terminal.

### SUMMARY

One non-limiting and exemplary embodiment provides a battery with high reliability.

In one general aspect, the techniques disclosed here feature a battery including a power generating element including a first electrode, a second electrode, and an electrolyte layer between the first electrode and the second electrode, and a first extraction electrode, wherein the first electrode includes a first current collector and a first active material layer between the first current collector and the electrolyte layer, and the first extraction electrode includes: a first conductive member connected to a first surface of the first current collector, the first surface being opposite to the first active material layer; and a first lead connected to the first conductive member.

The present disclosure can provide a battery with high reliability.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a perspective view of the structure of a battery known in the related art;

FIG. 2 is a cross-sectional view of the battery taken along line II-II in FIG. 1;

FIG. 3 illustrates a plan view and a cross-sectional view of a battery according to a first embodiment;

FIG. 4 is a flowchart illustrating a method for producing the battery according to the first embodiment;

FIG. 5 illustrates a plan view and a cross-sectional view of a battery according to a second embodiment;

FIG. 6 is a flowchart illustrating a method for producing the battery according to the second embodiment;

FIG. 7 illustrates a plan view and a cross-sectional view of a battery according to a third embodiment;

FIG. 8 illustrates a plan view and a cross-sectional view of a battery according to a fourth embodiment;

FIG. 9 illustrates a plan view and a cross-sectional view of a battery according to a fifth embodiment;

FIG. 10 illustrates a plan view and a cross-sectional view of a battery according to a sixth embodiment;

FIG. 11 illustrates a plan view and a cross-sectional view of a battery according to a seventh embodiment;

FIG. 12 illustrates a plan view and a cross-sectional view of a battery according to a modification of the seventh embodiment;

FIG. 13 is a plan view of an extraction electrode according to Modification 1 of the embodiments; and

FIG. 14 illustrates a plan view and a cross-sectional view of an extraction electrode according to Modification 2 of the embodiments.

### DETAILED DESCRIPTIONS

Underlying Knowledge Forming Basis of the Present Disclosure

The inventors of the present disclosure have found that batteries known in the related art face the following problems.

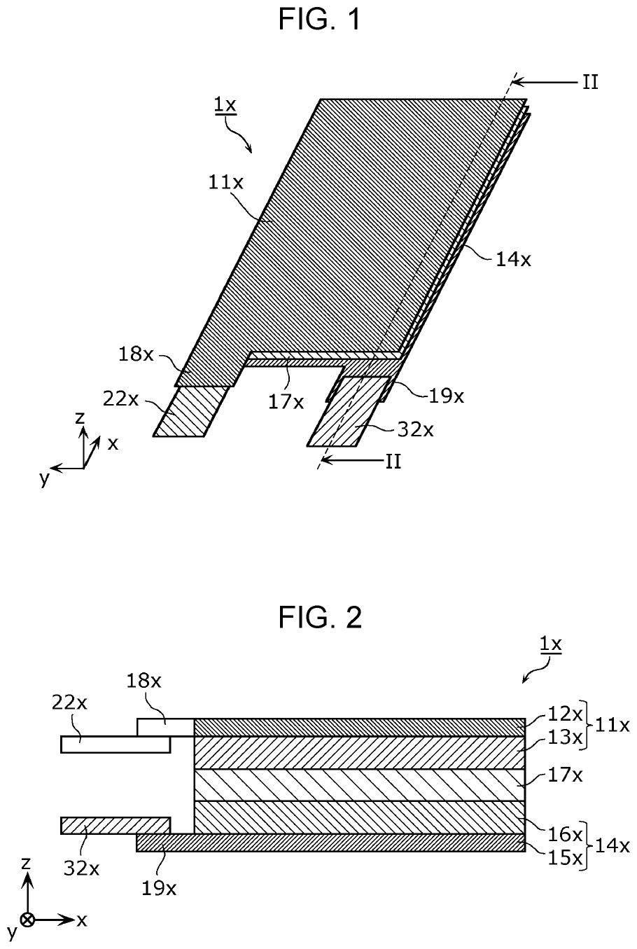

FIG. 1 is a perspective view of the structure of a battery 1x known in the related art. FIG. 2 is a cross-sectional view of the battery 1x taken along line II-II in FIG. 1.

As illustrated in FIG. 1 and FIG. 2, the battery 1x known in the related art is an all-solid-state battery including a positive electrode 11x, a negative electrode 14x, and a solid electrolyte layer 17x. The positive electrode 11x includes a positive electrode current collector 12x and a positive electrode active material layer 13x. The negative electrode 14x includes a negative electrode current collector 15x and a negative electrode active material layer 16x. The solid electrolyte layer 17x is disposed between the positive electrode 11x and the negative electrode 14x.

In the battery 1x known in the related art, the positive electrode current collector 12x has a tab 18x, as illustrated in FIG. 1 and FIG. 2. The tab 18x is a portion of the positive electrode current collector 12x and is not covered by the positive electrode active material layer 13x. A lead 22x is attached to the tab 18x. Similarly, the negative electrode current collector 15x has a tab 19x. The tab 19x is a portion of the negative electrode current collector 15x and is not covered by the negative electrode active material layer 16x. A lead 32x is attached to the tab 19x. The leads 22x and 32x are extraction electrodes of the battery 1x.

To produce the battery 1x, a multilayer body including the positive electrode 11x, the solid electrolyte layer 17x, and the negative electrode 14x is compressed by pressing (hereinafter referred to as bond pressing) in the thickness direction. The density of each of the positive electrode active material layer 13x, the negative electrode active material layer 16x, and the solid electrolyte layer 17x can be improved by bond pressing to form desirable contact interfaces between grains.

Each layer is elongated in the direction perpendicular to the compression direction by bond pressing. The distortion caused by this elongation most affects the outer peripheral portion, or open end, of each layer. For this, the thickness of each layer may differ between the central portion and the outer peripheral portion of the battery 1x. In this case, the outer peripheral portion of the battery 1x fails to have a designed thickness and thus fails to have the designed battery performance. This reduces the reliability of the entire battery including the outer peripheral portion.

To deal with this, the outer peripheral portion may be removed. In other words, the battery 1x having uniform properties over the entire surface can be realized by cutting out the outer peripheral portion that fails to have a designed thickness.

For the battery 1x illustrated in FIG. 1 and FIG. 2, however, the outer peripheral portion needs to be cut out with the tabs 18x and 19x attached. This requires very high cutting accuracy. It is thus difficult to provide the battery 1x with high reliability from which the outer peripheral portion has been cut out while the tabs 18x and 19x have been formed.

As described above, the battery 1x known in the related art has a problem of low reliability.

A battery according to an aspect of the present disclosure includes a power generating element including a first electrode, a second electrode, and an electrolyte layer between the first electrode and the second electrode, and a first extraction electrode. The first electrode includes a first current collector and a first active material layer between the first current collector and the electrolyte layer. The first extraction electrode includes: a first conductive member connected to a first surface of the first current collector, the first surface being opposite to the first active material layer; and a first lead connected to the first conductive member.

Since the first lead is connected to the first current collector through the first conductive member as described above, for example, the first lead can be attached to the first current collector after cutting out the outer peripheral portion of the power generating element. It is thus easy to improve the reliability of the performance of the power generating element without requiring high accuracy for cutting the outer peripheral portion out. Therefore, the battery having high reliability can be provided according to this aspect.

By the way, a lead commonly has a thickness of about 100 μm. When a lead is directly connected to a current collector, local unevenness corresponding to the thickness of the lead is generated at the joint. A battery may receive a large confining pressure from the outside of the battery in practical use. In this case, the presence of local unevenness in the current collector generates variations in confining pressure received by the battery. The variations in confining pressure may cause local acceleration of degradation in battery performance to reduce battery reliability.

In the battery according to an aspect of the present disclosure, for example, the first conductive member may have a region that does not overlap the first current collector in plan view. The first lead may be connected to the first conductive member in the region.

This configuration can eliminate or reduce variations in confining pressure received by the power generating element because the first lead does not overlap the first current collector. Therefore, the reliability of the battery can be further improved.

For example, the first conductive member may be in contact with the first surface of the first current collector.

This configuration can reduce contact resistance between the first conductive member and the first current collector and can thus improve the extraction efficiency of the battery.

For example, the battery according to an aspect of the present disclosure may further include an adhesive layer between the first current collector and the first conductive member. The first conductive member may be connected to the first surface of the first current collector through the adhesive layer.

This configuration can increase the bonding strength between the first conductive member and the first current collector and can thus prevent the first conductive member and the first lead from being detached from the power generating element. The reliability of the battery can be improved accordingly.

For example, the adhesive layer may have electrical conductivity.

This configuration can improve the extraction efficiency of the battery while increasing the bonding strength between the first conductive member and the first current collector.

For example, the first current collector and the first conductive member may be formed by using the same material. In other words, the first current collector and the first conductive member may contain the same material.

This configuration can increase the close contact between the first conductive member and the first current collector and can further reduce contact resistance between the first conductive member and the first current collector. Therefore, the extraction efficiency of the battery can be further improved.

For example, the thickness of the conductive member may be larger than or equal to the thickness of the first current collector.

This configuration can increase the strength of the first conductive member and can thus prevent breakage or other damages. The reliability of the battery can be improved accordingly.

For example, the battery according to an aspect of the present disclosure may further include an insulating layer having a frame shape along the edge face of the power generating element.

This configuration can suppress short-circuiting between the positive electrode and the negative electrode in a peripheral portion of the power generating element to increase the reliability of the battery.

In addition, for example, the insulating layer may cover an end portion of the first surface of the first current collector.

The insulating layer can accordingly protect the outer periphery of the first conductive member and can thus improve the reliability of the battery.

For example, the first conductive member may cover the entire first surface of the first current collector in plan view.

This configuration can maximize the contact area between the first conductive member and the first current collector and can thus reduce contact resistance between the first conductive member and the first current collector. Therefore, the extraction efficiency of the battery can be improved.

For example, the sheet resistance of the first conductive member may decrease with distance from the first lead.

This configuration can prevent or reduce local electric field concentration and can thus prevent or reduce local battery degradation. Therefore, the reliability of the battery can be improved.

For example, the first conductive member may have a plurality of through-holes. At least one of the arrangement density or the opening area of the through-holes may decrease with distance from the first lead.

This configuration can, for example, prevent or reduce local electric field concentration while maintaining the thickness of the first conductive member uniform. The uniform thickness of the first conductive member can eliminate or reduce variations in confining pressure applied to the power generating element. Therefore, the reliability of the battery can be further improved.

For example, the thickness of the first conductive member may increase with distance from the first lead.

The local electric field concentration can be prevented or reduced by varying the thickness of the first conductive member. Therefore, the extraction efficiency of the battery can be improved.

For example, the battery according to an aspect of the present disclosure may further include a second extraction electrode. The second electrode includes a second current collector and a second active material layer between the second current collector and the electrolyte layer. The second extraction electrode includes: a second conductive member connected to a second surface of the second current collector, the second surface being opposite to the second active material layer; and a second lead connected to the second conductive member.

Since the second lead is accordingly connected to the second current collector through the second conductive member, for example, the second lead can be attached to the second current collector after cutting out the outer peripheral portion of the power generating element. The reliability of the performance of the power generating element can thus be improved without requiring high accuracy for cutting the outer peripheral portion out. Therefore, a battery having high reliability can be provided according to this aspect.

For example, the first conductive member may project from the power generating element in a first direction in plan view. The second conductive member may project from the power generating element in a second direction in plan view. The first lead may be connected to a projecting portion of the first conductive member. The second lead may be connected to a projecting portion of the second conductive member.

Accordingly, neither the first lead nor the second lead overlaps the power generating element in plan view, which can eliminate or reduce variations in confining pressure received by the power generating element. Therefore, the reliability of the battery can be further improved.

For example, the first direction may be opposite to the second direction.

Accordingly, the first lead can be spaced apart from the second lead. This configuration can suppress short-circuiting to improve the reliability of the battery.

For example, the first direction may be the same as the second direction.

The first lead and the second lead can be accordingly disposed close to each other, which is desired if there is a restriction on mounting area. For example, when the battery is mounted on a board, a small area is used to connect the battery to the board. This can increase the degree of freedom in layout of, for example, other circuit elements and wires mounted on the board.

For example, the first direction may be perpendicular to the second direction.

The extraction direction of each of the positive electrode and the negative electrode of the battery can be adjusted depending on the requirements for mounting.

For example, the electrolyte layer may contain a solid electrolyte having lithium-ion conductivity.

An all-solid-state battery with high reliability can be provided accordingly.

For example, the battery according to an aspect of the present disclosure may include a plurality of the power generating elements. The first extraction electrode may be connected to the first current collector of a first power generating element that is one of the plurality of power generating elements. A second power generating element that is one of the plurality of power generating elements may be disposed on the second electrode side of the first power generating element.

Since the battery includes a plurality of the power generating elements, at least one of the extracted voltage or the battery capacity is high, and the battery has high reliability.

For example, the second electrode of the first power generating element may be connected to the first electrode of the second power generating element.

This configuration can increase the voltage extracted from the battery.

For example, the second electrode of the first power generating element may be connected to the second electrode of the second power generating element.

This configuration can increase the capacity of the battery.

Embodiments will be described below with reference to the drawings.

Any embodiment described below illustrates comprehensive or specific examples. The values, shapes, materials, components, the arrangement positions and connection configuration of the components, steps, the sequence of the steps, and the like described in the following embodiments are illustrative only and should not be construed as limiting the present disclosure. Among the components in the following embodiments, the components that are not mentioned in the independent claims are described as optional components.

The drawings are all schematic views and are not necessarily accurately drawn. Therefore, for example, the drawings are not necessarily drawn to scale. In the drawings, components having substantially the same function are denoted by the same reference characters, and the redundant description thereof is omitted or simplified.

In this specification, the terms expressing the relationship between elements, such as parallel or perpendicular, the terms expressing the shapes of elements, such as rectangle or circle, and the numerical ranges are not expressions having only strict meanings but expressions having meanings in a substantially equivalent range, for example, including a difference of about several percentages.

In this specification and the drawings, the x-axis, y-axis, and z-axis represent three axes in a three-dimensional cartesian coordinate system. In each embodiment, the z-axis direction corresponds to the thickness direction of the battery. The term “thickness direction” in this specification refers to the direction perpendicular to a plane on which layers are stacked. The positive side of the z-axis may be treated as “upper” and “upper side”, and the negative side of the z-axis may be treated as “lower” and “lower side”. For example, the surface of each layer of a battery on the positive side of the z-axis may be referred to as an “upper surface”, and the surface on the negative side of the z-axis may be referred to as a “lower surface”.

The “plan view” in this specification refers to the view of a battery as seen in the stacking direction of the battery. The “thickness” in this specification refers to the length of a battery and each layer in the stacking direction.

The “inner” and “outer” of “inner side”, “outer side”, and other terms in this specification refer to inside and outside a battery as seen in the stacking direction of the battery.

In this specification, the terms “upper” and “lower” regarding the structure of the battery do not refer to a higher level (vertically above) and a lower level (vertically below) in absolute space recognition but are used as terms defined by the relative positional relationship based on the stacking order in the multilayer structure. The terms “above” and “below” are used not only when two components are spaced apart from each other with another component therebetween, but also when two components are disposed in close contact with each other so that they touch each other.

### First Embodiment

### Overview of Battery

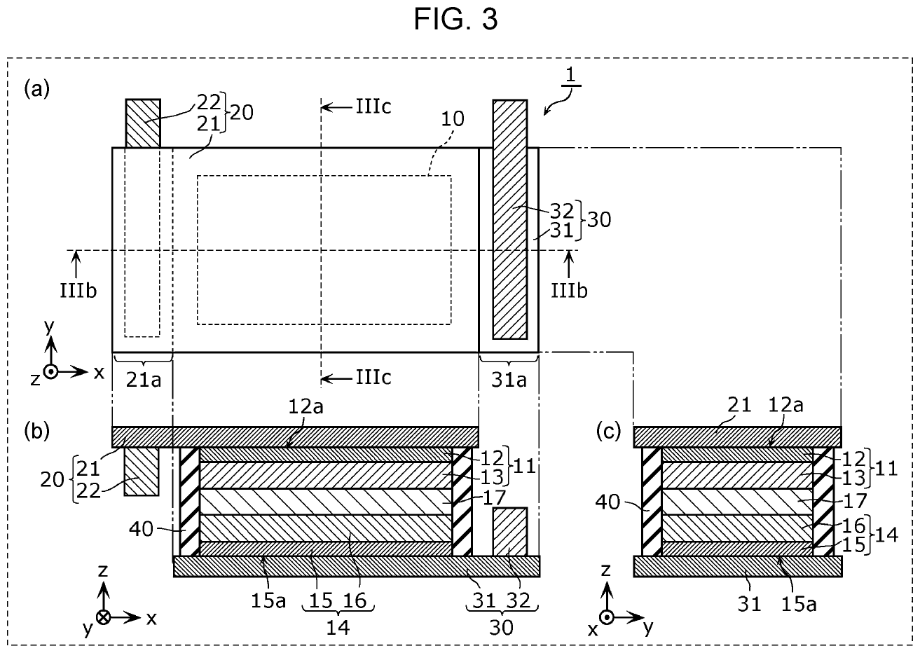

First, a battery according to a first embodiment will be described with reference to FIG. 3.

FIG. 3 illustrates a plan view and a cross-sectional view of a battery 1 according to this embodiment. Specifically, FIG. 3(a) is a plan view of the battery 1 as seen from the positive side of the z-axis. FIG. 3(b) illustrates the cross section taken along line IIIb-IIIb in FIG. 3(a). FIG. 3(c) illustrates the cross section taken along line IIIc-IIIc in FIG. 3(a). FIG. 3(c) does not illustrate a first lead 22 located behind the cross section. The same applies to the following figures.

As illustrated in FIG. 3, the battery 1 includes a power generating element 10, a first extraction electrode 20, a second extraction electrode 30, and an insulating layer 40. The battery 1 is an all-solid-state battery.

The power generating element 10 includes a first electrode 11, a second electrode 14, and a solid electrolyte layer 17. The first electrode 11 includes a first current collector 12 and a first active material layer 13 in contact with the first current collector 12. The second electrode 14 is a counter electrode to the first electrode 11. The second electrode 14 includes a second current collector 15 and a second active material layer 16 in contact with the second current collector 15. The solid electrolyte layer 17 is an example of the solid electrolyte layer located between the first electrode 11 and the second electrode 14 and is in contact with each of the first active material layer 13 and the second active material layer 16.

The power generating element 10 is a multilayer body including the first electrode 11, the second electrode 14, and the solid electrolyte layer 17, from which the outer peripheral portion has been cut out. In other words, the power generating element 10 is obtained by performing bond pressing on a multilayer body with stacked layers, and cutting out the outer peripheral portion in which thickness unevenness may occur. Therefore, the power generating element 10 eliminates or reduces variations in battery performance to improve reliability.

In this embodiment, the first extraction electrode 20 and the second extraction electrode 30 are connected to the power generating element 10 that has high reliability and that has the outer peripheral portion cut out. This configuration provides the battery 1 with high reliability.

A specific configuration of each of the power generating element 10, the first extraction electrode 20, and the second extraction electrode 30 will be described below.

### Power Generating Element

First, the components of the power generating element 10 will be described in detail.

In this embodiment, the first electrode 11 is a positive electrode, and the second electrode 14 is a negative electrode. In other words, the first current collector 12 is a positive electrode current collector, and the first active material layer 13 contains a positive electrode active material. The second current collector 15 is a negative electrode current collector, and the second active material layer 16 contains a negative electrode active material.

The first electrode 11 may be a negative electrode, and the second electrode 14 may be a positive electrode. In other words, the first current collector 12 may be a negative electrode current collector, and the first active material layer 13 may contain a negative electrode active material. The second current collector 15 may be a positive electrode current collector, and the second active material layer 16 may contain a positive electrode active material.

The first current collector 12, the first active material layer 13, the solid electrolyte layer 17, the second active material layer 16, and the second current collector 15 each have a rectangular shape in plan view. The first current collector 12, the first active material layer 13, the solid electrolyte layer 17, the second active material layer 16, and the second current collector 15 each have any shape in plan view and may have a shape other than a rectangle, such as a circle, an oval, or a polygon, in plan view.

In this embodiment, the first current collector 12, the first active material layer 13, the solid electrolyte layer 17, the second active material layer 16, and the second current collector 15 have the same size, and the contours of these components coincide with each other in plan view. However, the configuration is not limited to this. For example, the first active material layer 13 may be smaller than the second active material layer 16. The first active material layer 13 and the second active material layer 16 may be smaller than the solid electrolyte layer 17.

In this specification, the first current collector 12 and the second current collector 15 may be collectively referred to simply as a “current collector” when they are not distinguished from each other. The current collector is formed of any conductive material.

The current collector is formed of, for example, a foil, sheet, or mesh made of, for example, stainless steel, nickel (Ni), aluminum (Al), iron (Fe), titanium (Ti), copper (Cu), palladium (Pd), gold (Au), and platinum (Pt), or an alloy of two or more of these metals. The material of the current collector is appropriately selected in consideration of the production process, the properties of not melting or decomposing at operating temperatures and operating pressures, the battery operating potential applied to the current collector, and electrical conductivity. The material of the current collector may also be selected according to the required tensile strength and heat resistance. The current collector may be, for example, a high-strength electrolytic copper foil, or a clad material in which dissimilar metal foils are stacked on top of one another. In this embodiment, the first current collector 12 contains aluminum as a main component. The second current collector 15 contains copper as a main component.

The current collector has, for example, a thickness in a range larger than or equal to 10 μm and less than or equal to 100 μm. The surface of the current collector may have irregularities with projections and recesses in order to improve the close contact between the first active material layer 13 and the second active material layer 16. The surface of the current collector may be coated with an adhesive component, such as an organic binder. This can strengthen the bonding properties of the interface between the current collector and other layers to improve the mechanical and thermal reliability of the battery 1 and the cycle characteristics.

The first active material layer 13 is located between the first current collector 12 and the solid electrolyte layer 17. Specifically, the first active material layer 13 is disposed in contact with a main surface of the first current collector 12, the main surface being adjacent to the solid electrolyte layer 17. In this embodiment, the first active material layer 13 contains at least a positive electrode active material. In other words, the first active material layer 13 is a layer mainly containing a positive electrode material, such as a positive electrode active material.

The positive electrode active material is a material in which metal ions, such as lithium (Li) ions or magnesium (Mg) ions, are intercalated into or deintercalated from the crystal structure at a potential higher than the potential of the negative electrode to cause oxidation or reduction. The type of positive electrode active material can be appropriately selected depending on the type of the battery 1 and may be a known positive electrode active material.

Examples of the positive electrode active material include a compound containing lithium and a transition metal element, such as an oxide containing lithium and a transition metal element, and a phosphate compound containing lithium and a transition metal element. Examples of the oxide containing lithium and a transition metal element include LiNiₓM₁₋ₓO₂ (wherein M is at least one element selected from Co, Al, Mn, V, Cr, Mg, Ca, Ti, Zr, Nb, Mo, and W, x is 0<x≤1), layered oxides, such as lithium cobalt oxide (LiCoO₂), lithium nickel oxide (LiNiO₂), lithium manganese oxide (LiMn₂O₄), or lithium manganate with a spinel structure (e.g., LiMn₂O₄, Li₂MnO₃, LiMnO₂). Examples of the phosphate compound containing lithium and a transition metal element include lithium iron phosphate with an olivine structure (LiFePO₄). Sulfur (S) or a sulfide, such as lithium sulfide (Li₂S), can also be used as a positive electrode active material. In this case, positive electrode active material particles coated with lithium niobate (LiNbO₃) or other substances or containing lithium niobate (LiNbO₃) or other substances can be used as a positive electrode active material. The positive electrode active material may be only one of these materials or a combination of two or more of these materials.

As described above, the first active material layer 13, which is a positive electrode active material layer, contains at least a positive electrode active material. The first active material layer 13 may be a mixture layer formed of a mixture of a positive electrode active material and other additives. Examples of other additives may include solid electrolytes, such as inorganic solid electrolytes or sulfide solid electrolytes, conductive assistants, such as acetylene black, and binders for binding, such as polyethylene oxide or polyvinylidene fluoride. The lithium-ion conductivity as well as electron conductivity of the first active material layer 13 can be improved by mixing the positive electrode active material and other additives, such as a solid electrolyte, at a predetermined ratio.

The first active material layer 13 has, for example, a thickness in a range larger than or equal to 5 μm and less than or equal to 300 μm, but the thickness is not limited to this.

The second active material layer 16 is located between the second current collector 15 and the solid electrolyte layer 17. Specifically, the second active material layer 16 is disposed in contact with a main surface of the second current collector 15, the main surface being adjacent to the solid electrolyte layer 17. In this embodiment, the second active material layer 16 contains at least a negative electrode active material. In other words, the second active material layer 16 is a layer mainly containing a negative electrode material, such as a negative electrode active material.

The negative electrode active material is a material in which metal ions, such as lithium (Li) ions or magnesium (Mg) ions, are intercalated into or deintercalated from the crystal structure at a potential lower than the potential of the positive electrode to cause oxidation or reduction. The type of negative electrode active material can be appropriately selected depending on the type of the battery 1 and may be a known negative electrode active material.

Examples of the negative electrode active material include carbon materials, such as natural graphite, artificial graphite, graphite carbon fiber, or resin heat-treated carbon, and alloy materials that can be mixed with a solid electrolyte. Examples of the alloy materials may include lithium alloys, such as LiAl, LiZn, Li₃Bi, Li₃Cd, Li₃Sb, Li_{4.4}Pb, Li_{4.4}Sn, Li_{0.17}C, and LiC₆, lithium transition metal oxides, such as lithium titanate (Li₄Ti₅O₁₂), and metal oxides, such as zinc oxide (ZnO) and silicon oxide (SiOx). The negative electrode active material may be only one of these materials or a combination of two or more of these materials.

As described above, the second active material layer 16, which is a negative electrode active material layer, contains at least a negative electrode active material. The second active material layer 16 may be a mixture layer formed of a mixture of a negative electrode active material and other additives. Examples of other additives may include solid electrolytes, such as inorganic solid electrolytes or sulfide solid electrolytes, conductive assistants, such as acetylene black, and binders for binding, such as polyethylene oxide or polyvinylidene fluoride. The lithium-ion conductivity as well as electron conductivity of the second active material layer 16 can be improved by mixing the negative electrode active material and other additives, such as a solid electrolyte, at a predetermined ratio.

The second active material layer 16 has, for example, a thickness in a range larger than or equal to 5 μm and less than or equal to 300 μm, but the thickness is not limited to this.

The solid electrolyte layer 17 is disposed between and in contact with the first active material layer 13 and the second active material layer 16. The solid electrolyte layer 17 contains at least a solid electrolyte. The solid electrolyte layer 17 contains, for example, a solid electrolyte as a main component.

The solid electrolyte is any known ion-conductive solid electrolyte for batteries. Examples of the solid electrolyte may include solid electrolytes that conduct metal ions, such as a lithium ion or a magnesium ion. The type of solid electrolyte is appropriately selected depending on conducting ion species.

Examples of solid electrolytes may include inorganic solid electrolytes, such as sulfide solid electrolytes or oxide solid electrolytes. Examples of sulfide solid electrolytes may include lithium-containing sulfides, such as Li₂S—P₂S₅, Li₂S—SiS₂, Li₂S—B₂S₃, Li₂S—GeS₂, Li₂S—SiS₂—LiI, Li₂S—SiS₂—Li₃PO₄, Li₂S—Ge₂S₂, Li₂S—GeS₂—P₂S₅, and Li₂S—GeS₂—ZnS. Examples of oxide solid electrolytes may include lithium-containing metal oxides, such as Li₂O—SiO₂, and Li₂O—SiO₂—P₂O₅, lithium-containing metal nitrides, such as LiₓP_{y}O_{1-z}N_{z}, lithium phosphate (Li₃PO₄), and lithium-containing transition metal oxides, such as lithium titanium oxide. The solid electrolyte may be only one of these materials or a combination of two or more of these materials. In this embodiment, the solid electrolyte layer 17 contains, for example, a solid electrolyte having lithium-ion conductivity.

The solid electrolyte layer 17 may contain, for example, a binder for binding, such as polyethylene oxide or polyvinylidene fluoride, in addition to the above solid electrolyte material.

The solid electrolyte layer 17 has, for example, a thickness in a range larger than or equal to 5 μm and less than or equal to 150 μm, but the thickness is not limited to this.

The material of the solid electrolyte may be in the form of aggregates of particles. The material of the solid electrolyte may have a sintered structure.

### First Extraction Electrode and Second Extraction Electrode

Next, the first extraction electrode 20 and the second extraction electrode 30 will be described in detail.

As illustrated in FIG. 3, the first extraction electrode 20 includes a first conductive member 21 and a first lead 22. The second extraction electrode 30 includes a second conductive member 31 and a second lead 32.

The first conductive member 21 is connected to a main surface 12a of the first current collector 12. The main surface 12a is a first surface of the first current collector 12, the first surface being opposite to the first active material layer 13. In this embodiment, the first conductive member 21 is in contact with the main surface 12a of the first current collector 12, as illustrated in FIGS. 3(b) and 3(c). The first conductive member 21 and the first current collector 12 are in surface contact with each other with a large contact area.

In this embodiment, the first conductive member 21 covers the entire main surface 12a of the first current collector 12 in plan view. The contour of the main surface 12a coincides with the contour of the power generating element 10 illustrated in FIG. 3(a). The first conductive member 21 is larger than the first current collector 12 in plan view. The first conductive member 21 has a region 21a that does not overlap the first current collector 12 in plan view.

The first conductive member 21 is a planar member having electrical conductivity. Specifically, the first conductive member 21 is a metal foil. Examples of the material of the first conductive member 21 include stainless steel, nickel, aluminum, iron, titanium, copper, palladium, gold, and platinum, and an alloy of two or more of these metals. The first conductive member 21 is formed by using, for example, the same material as the first current collector 12. In other words, the first conductive member 21 may contain, for example, the same material as the first current collector 12. For example, when the first current collector 12 is a metal foil containing aluminum as a main component, the first conductive member 21 also contains aluminum as a main component.

The first conductive member 21 has, for example, a thickness in a range larger than or equal to 10 μm and less than or equal to 100 μm. The thickness of the first conductive member 21 is larger than or equal to the thickness of the first current collector 12. For example, when the thickness of the first conductive member 21 is larger than the thickness of the first current collector 12, the first conductive member 21 has high strength.

The first lead 22 is connected to the first conductive member 21. Specifically, the first lead 22 is connected to the first conductive member 21 in the region 21a. The region 21a is part of the first conductive member 21 and projects from the power generating element 10 in the first direction in plan view. The first direction is specifically a negative x-axis direction. The region 21a is, for example, a part of the first conductive member 21 that does not overlap the second conductive member 31 in plan view. As illustrated in FIG. 3(b), the first lead 22 is connected to a main surface of the first conductive member 21, the main surface being adjacent to the power generating element 10.

The first lead 22 is a wire-shaped, foil-shaped or sheet-shaped member made of copper, aluminum, nickel, or stainless steel, or other metals, or coated with any of these metals. The first lead 22 has a thickness of, for example, 100 μm. The first lead 22 is formed by using, for example, the same material as the first conductive member 21. In other words, the first lead 22 may contain, for example, the same material as the first conductive member 21. The first lead 22 is, for example, ultrasonically connected to the first conductive member 21. The first lead 22 and the first conductive member 21 may be connected to each other by using a conductive adhesive, such as solder.

The first lead 22 is elongated in one direction. In this embodiment, the plan view shape of the first lead 22 is rectangular and elongated in the y-axis direction, as illustrated in FIG. 3(a). The first lead 22 is extended from the first conductive member 21 in the positive y-axis direction. A tip portion of the first lead 22 in the extending direction is extended from a laminate member (not shown) that seals substantially the entire battery 1 and is used for electrical and physical connection to other boards or other components.

The second conductive member 31 is connected to a main surface 15a of the second current collector 15. The main surface 15a is a second surface of the second current collector 15, the second surface being opposite to the second active material layer 16. In this embodiment, the second conductive member 31 is in contact with the main surface 15a of the second current collector 15, as illustrated in FIGS. 3(b) and 3(c). The second conductive member 31 and the second current collector 15 are in surface contact with each other with a large contact area.

In this embodiment, the second conductive member 31 covers the entire main surface 15a of the second current collector 15 in plan view. The contour of the main surface 15a coincides with the contour of the power generating element 10 illustrated in FIG. 3(a). The second conductive member 31 is larger than the second current collector 15 in plan view. The second conductive member 31 has a region 31a that does not overlap the second current collector 15 in plan view.

The second conductive member 31 is a planar member having electrical conductivity. Specifically, the second conductive member 31 is a metal foil. Examples of the material of the second conductive member 31 include stainless steel, nickel, aluminum, iron, titanium, copper, palladium, gold, and platinum, and an alloy of two or more of these metals. The second conductive member 31 is formed by using, for example, the same material as the second current collector 15. In other words, the second conductive member 31 may contain, for example, the same material as the second current collector 15. For example, when the second current collector 15 is a metal foil containing copper as a main component, the second conductive member 31 also contains copper as a main component.

The second conductive member 31 has, for example, a thickness in a range larger than or equal to 10 μm and less than or equal to 100 μm. The thickness of the second conductive member 31 is larger than or equal to the thickness of the second current collector 15. For example, when the thickness of the second conductive member 31 is larger than the thickness of the second current collector 15, the second conductive member 31 has high strength.

The second lead 32 is connected to the second conductive member 31. Specifically, the second lead 32 is connected to the second conductive member 31 in the region 31a. The region 31a is part of the second conductive member 31 and projects from the power generating element 10 in the second direction in plan view. Specifically, the second direction is a positive x-axis direction. In other words, the first direction is opposite to the second direction in this embodiment. The region 31a is, for example, a part of the second conductive member 31 that does not overlap the first conductive member 21 in plan view. As illustrated in FIG. 3(b), the second lead 32 is connected to a main surface of the second conductive member 31, the main surface being adjacent to the power generating element 10.

The second lead 32 is a wire-shaped, foil-shaped or sheet-shaped member made of copper, aluminum, nickel, or stainless steel, or other metals, or coated with any of these metals. The second lead 32 has a thickness of, for example, 100 μm. The second lead 32 is formed by using, for example, the same material as the second conductive member 31. In other words, the second lead 32 may contain, for example, the same material as the second conductive member 31. The second lead 32 is, for example, ultrasonically connected to the second conductive member 31. The second lead 32 and the second conductive member 31 may be connected to each other by using a conductive adhesive, such as solder.

The second lead 32 is elongated in one direction. In this embodiment, the plan view shape of the second lead 32 is rectangular and elongated in the y-axis direction, as illustrated in FIG. 3(a). The second lead 32 is extended from the second conductive member 31 in the positive y-axis direction. In this embodiment, the extending direction of the second lead 32 is the same as the extending direction of the first lead 22. A tip portion of the second lead 32 in the extending direction is extended from a laminate member (not shown) that seals substantially the entire battery 1 and is used for electrical and physical connection to other boards or other components.

As illustrated in FIG. 3(a), the first lead 22 and the second lead 32 are disposed with the power generating element 10 therebetween in plan view. In other words, the power generating element 10 is located between the first lead 22 and the second lead 32 in plan view. The first conductive member 21 and the second conductive member 31 are rectangular with the same size in plan view and offset from each other in the longitudinal direction. The power generating element 10 and the insulating layer 40 are located in an overlap between the first conductive member 21 and the second conductive member 31.

In this embodiment, connection between the first extraction electrode 20 and the power generating element 10 and connection between the second extraction electrode 30 and the power generating element 10 are maintained by the laminate member (not shown) that seals the battery 1. The laminate member is a sealing member for the purpose of protecting the battery 1 and formed by using a metal material or a resin material. The entire battery 1 other than the tip portions of the first lead 22 and the second lead 32 is vacuum-sealed with the laminate member.

When the inside of the laminate member is under vacuum, atmospheric pressure can apply a confining force to the power generating element 10 of the battery 1 in the thickness direction through the laminate member. The confining force through the laminate member causes the first conductive member 21 to come into close contact with the first current collector 12 and causes the second conductive member 31 to come into close contact with the second current collector 15. This configuration can reduce contact resistance between the first conductive member 21 and the first current collector 12 and contact resistance between the second conductive member 31 and the second current collector 15. In addition, the confining force through the laminate member can suppress, for example, positional misalignment between the first conductive member 21 and the first current collector 12 and positional misalignment between the second conductive member 31 and the second current collector 15.

### Insulating Layer

The insulating layer 40 is an insulating layer having a frame shape along the edge face of the power generating element 10. The insulating layer 40 covers the entire periphery of the power generating element 10 in plan view so as not to expose the edge face of the power generating element 10.

The insulating layer 40 is formed by using a commonly known material of a battery sealing member, such as a sealer. For example, the insulating layer 40 is formed by using an insulating resin material. Examples of the insulating resin material include an epoxy resin, an acrylic resin, and a polyimide resin.

The insulating layer 40 has, for example, a width larger than or equal to several micrometers, but the width is not limited to this.

### Production Method

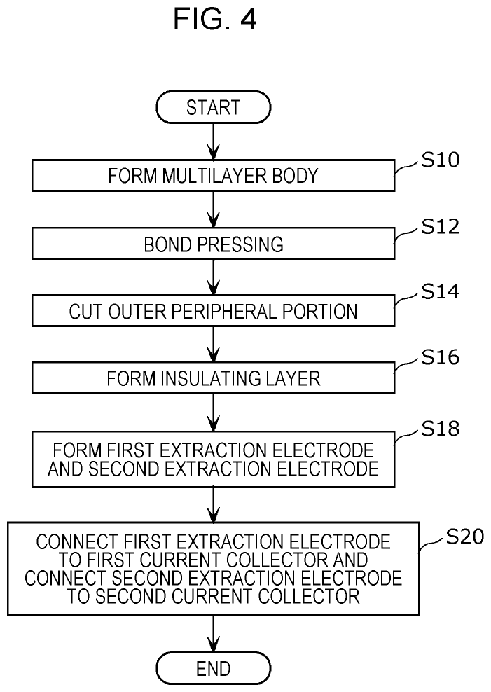

Next, a method for producing the battery 1 according to this embodiment will be described with reference to FIG. 4. FIG. 4 is a flowchart illustrating the method for producing the battery 1 according to this embodiment.

As illustrated in FIG. 4, a multilayer body having the same configuration as the power generating element 10 is formed first (S10). The multilayer body is the power generating element 10 before bond pressing and cutting of the outer peripheral portion and includes the first electrode 11, the solid electrolyte layer 17, and the second electrode 14 before bond pressing and cutting of the outer peripheral portion. The multilayer body can be formed by using a known method for forming a power generating element.

Next, the formed multilayer body is subjected to bond pressing (S12). In this step, the designed battery characteristics can be realized in a central portion of the multilayer body. After bond pressing, the outer peripheral portion of the multilayer body is cut out (S14). This step can form the power generating element 10 having high reliability and having less variations in battery performance in the plane.

Next, the insulating layer 40 is formed (S16). For example, the insulating layer 40 is formed by applying a resin material so as to cover the entire edge face of the power generating element 10 along the outer periphery of the power generating element 10, and curing the resin material.

Next, the first extraction electrode 20 and the second extraction electrode 30 are formed (S18). Specifically, the first extraction electrode 20 is formed by ultrasonically connecting the first lead 22 to an end portion of the first conductive member 21. Similarly, the second extraction electrode 30 is formed by ultrasonically connecting the second lead 32 to an end portion of the second conductive member 31.

Next, the first extraction electrode 20 is connected to the first current collector 12, and the second extraction electrode 30 is connected to the second current collector 15 (S20). For example, the battery 1 is sealed by lamination while the first conductive member 21 is positioned relative to the first current collector 12, and the second conductive member 31 is positioned relative to the second current collector 15. Accordingly, the first extraction electrode 20 is connected to the first current collector 12, and the second extraction electrode 30 is connected to the second current collector 15. In positioning, each extraction electrode may be temporarily fixed to the power generating element 10 by using an adhesive tape or the like. The adhesive tape is, for example, applied from the outside of each of the first extraction electrode 20 and the second extraction electrode 30 to the insulating layer 40.

The extraction electrodes may be fixed to the respective current collectors by, for example, ultrasonic welding or spot welding instead of temporary fixing. The first lead 22 and the second lead 32 may be connected at the time of temporary fixing or after the extraction electrodes are fixed to the respective current collectors.

The formation of the insulating layer 40 (S16) may be omitted. In other words, the battery 1 may not have the insulating layer 40. The formation of the first extraction electrode 20 and the second extraction electrode 30 (S18) may be performed before the formation of the multilayer body (S10) or in parallel with the formation of the power generating element (S10 to S14).

Accordingly, the first lead 22 is connected to the first current collector 12 through the first conductive member 21 in the battery 1 according to this embodiment. As illustrated in FIG. 4, the first lead 22 can be attached to the first current collector 12 after cutting out an outer peripheral portion of the power generating element 10. The same applies to the second lead 32 and the second current collector 15.

It is thus easy to improve the reliability of the performance of the power generating element 10 without requiring high accuracy for cutting out an outer peripheral portion of the power generating element 10. Therefore, the battery 1 having high reliability can be provided according to this embodiment.

The first conductive member 21 and the second conductive member 31 each cover the entire surface of the power generating element 10 and thus eliminate or reduce variations in final confining pressure on the power generating element 10. Furthermore, the insulating layer 40 covers the edge face of the power generating element 10 and can thus suppress short-circuiting between the first electrode 11 and the second electrode 14.

### Second Embodiment

Next, a battery according to a second embodiment will be described. The second embodiment is different from the first embodiment mainly in that the insulating layer covering the edge face of the power generating element covers an end portion of the first surface of the first current collector and an end portion of the second surface of the second current collector. Hereinafter, points different from the first embodiment will be mainly described, and description of common points is omitted or simplified.

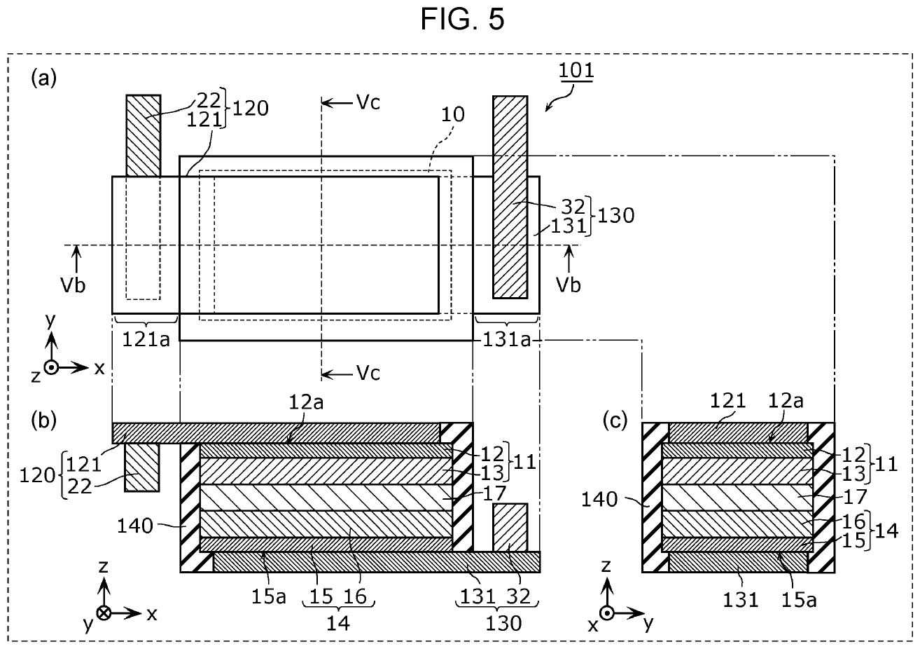

FIG. 5 illustrates a plan view and a cross-sectional view of a battery 101 according to this embodiment. Specifically, FIG. 5(a) is a plan view of the battery 101 as seen from the positive side of the z-axis. FIG. 5(b) illustrates the cross section taken along line Vb-Vb in FIG. 5(a). FIG. 5(c) illustrates the cross section taken along line Vc-Vc in FIG. 5(a).

As illustrated in FIG. 5, the battery 101 includes a power generating element 10, a first extraction electrode 120, a second extraction electrode 130, and an insulating layer 140. The power generating element 10 is the same as that in the first embodiment, and description thereof is thus omitted.

The first extraction electrode 120 includes a first conductive member 121 and a first lead 22. The second extraction electrode 130 includes a second conductive member 131 and a second lead 32. The first lead 22 and the second lead 32 are both the same as those in the first embodiment.

The first conductive member 121 is different in size from the first conductive member 21 according to the first embodiment. In this embodiment, the first conductive member 121 does not cover the entire main surface 12a of the first current collector 12, but covers only part of the main surface 12a of the first current collector 12. As illustrated in FIG. 5, the first conductive member 121 exposes an outer peripheral portion of the main surface 12a of the first current collector 12. Specifically, the main surface 12a of the first current collector 12 is rectangular in plan view, and the first conductive member 121 does not cover three sides of the main surface 12a, but covers only one side of the main surface 12a. In other words, the three sides of the first conductive member 121 are located inside three sides of the first current collector 12 in plan view.

The first conductive member 121 has a region 121a that does not overlap the first current collector 12 in plan view. The region 121a is part of the first conductive member 121 and projects from the power generating element 10 in the negative x-axis direction in plan view. A first lead 22 is connected to the region 121a.

The second conductive member 131 is different in size from the second conductive member 31 according to the first embodiment. In this embodiment, the second conductive member 131 does not cover the entire main surface 15a of the second current collector 15, but covers only part of the main surface 15a of the second current collector 15. As illustrated in FIG. 5, the second conductive member 131 exposes an outer peripheral portion of the main surface 15a of the second current collector 15. Specifically, the main surface 15a of the second current collector 15 is rectangular in plan view, and the second conductive member 131 does not cover three sides of the main surface 15a, but covers only one side of the main surface 15a. In other words, the three sides of the second conductive member 131 are located inside three sides of the second current collector 15 in plan view.

The second conductive member 131 has a region 131a that does not overlap the second current collector 15 in plan view. The region 131a is part of the second conductive member 131 and projects from the power generating element 10 in the positive x-axis direction in plan view. A second lead 32 is connected to the region 131a.

Like the insulating layer 40 according to the first embodiment, the insulating layer 140 has a frame shape along the edge face of the power generating element 10. The insulating layer 140 further covers an end portion of the main surface 12a of the first current collector 12. Specifically, the insulating layer 140 covers a portion of the main surface 12a of the first current collector 12 that is not covered by the first conductive member 121. For example, the insulating layer 140 is disposed along the edge face of the first conductive member 121, as illustrated in FIGS. 5(b) and 5(c). The insulating layer 140 is in contact with the edge face of the first conductive member 121. The upper surface of the insulating layer 140 is flush with the upper surface of the first conductive member 121. The insulating layer 140 may be spaced apart from the edge face of the first conductive member 121.

The insulating layer 140 further covers an end portion of the main surface 15a of the second current collector 15. Specifically, the insulating layer 140 covers a portion of the main surface 15a of the second current collector 15 that is not covered by the second conductive member 131. For example, the insulating layer 140 is disposed along the edge face of the second conductive member 131, as illustrated in FIGS. 5(b) and 5(c). The insulating layer 140 is in contact with the edge face of the second conductive member 131. The lower surface of the insulating layer 140 is flush with the lower surface of the second conductive member 131. The insulating layer 140 may be spaced apart from the edge face of the second conductive member 131.

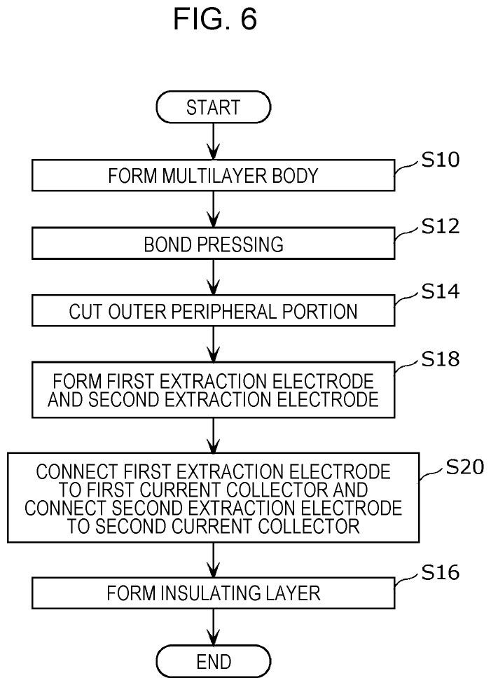

The method for producing the battery 101 is different from the method for producing the battery 1 according to the first embodiment. FIG. 6 is a flowchart illustrating the method for producing the battery 101 according to this embodiment.

As illustrated in FIG. 6, the steps (S10 to S14) of forming the power generating element 10 are the same as those in the method for producing the battery 1 according to the first embodiment. In this embodiment, the first extraction electrode 120 and the second extraction electrode 130 are formed (S18) after the outer peripheral portion of the multilayer body is cut out to form the power generating element 10. Subsequently, the first extraction electrode 120 is connected to the first current collector 12, and the second extraction electrode 130 is connected to the second current collector 15 (S20). In other words, the first extraction electrode 120 and the second extraction electrode 130 are connected to the power generating element 10 before the insulating layer 140 is formed. Since the insulating layer 140 cannot be formed after laminate sealing, the connection in Step S20 includes positioning and temporal fixing.

After positioning between the extraction electrodes and the current collectors, the insulating layer 140 is formed (S16) so as to cover an edge face of the power generating element 10 and an outer peripheral portion of each of the upper surface and the lower surface. Specifically, for example, the insulating layer 140 is formed by applying a resin material so as to cover the entire edge face of the power generating element 10 along the outer periphery of the power generating element 10 and an exposed portion of the main surface 12a of the first current collector 12 and an exposed portion of the main surface 15a of the second current collector 15, and curing the resin material.

When the insulating layer 140 is formed after establishing connection between the first extraction electrode 120 and the first current collector 12 and between the second extraction electrode 130 and the second current collector 15 as described above, unevenness is unlikely to form above and below the power generating element 10. Specifically, the upper surface of the first conductive member 121 can be made flush with the upper surface of the insulating layer 140, and the lower surface of the second conductive member 131 can be made flush with the lower surface of the insulating layer 140. Accordingly, the confining pressure after laminate sealing tends to uniformly act on the power generating element 10.

In this embodiment, a region of the first conductive member 121 other than the region 121a connected to the first lead 22 does not project outward from the power generating element 10 in plan view. For this, a projecting portion of the first conductive member 121 does not bend when the confining pressure is applied to the power generating element 10. The same applies to the second conductive member 131. It is thus possible to suppress short-circuiting between the positive electrode and the negative electrode.

### Third Embodiment

Next, a battery according to a third embodiment will be described. The third embodiment is different from the first and second embodiments mainly in the connection position of the second lead. Hereinafter, points different from the first and second embodiments will be mainly described, and description of common points is omitted or simplified.

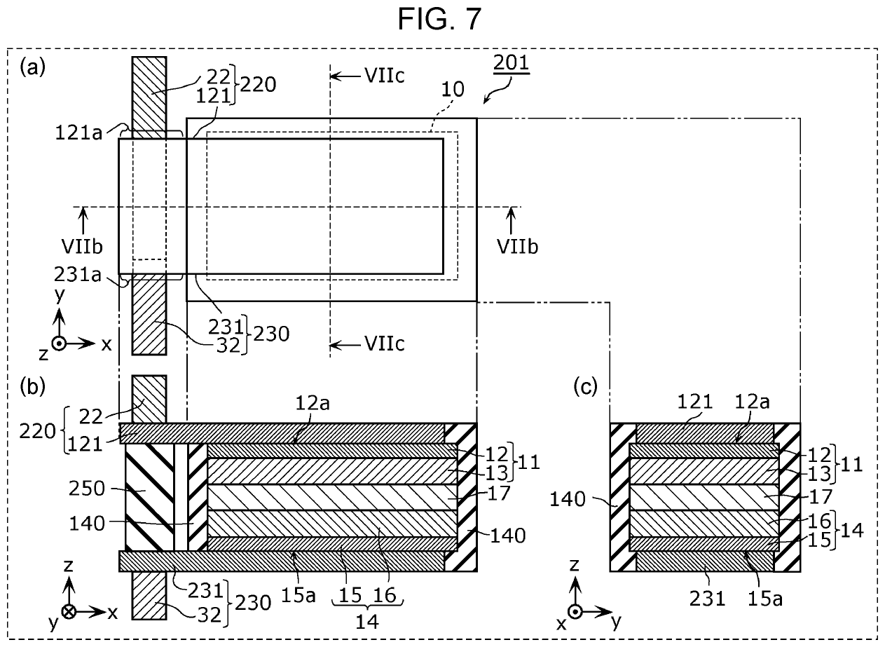

FIG. 7 illustrates a plan view and a cross-sectional view of a battery 201 according to this embodiment. Specifically, FIG. 7(a) is a plan view of the battery 201 as seen from the positive side of the z-axis. FIG. 7(b) illustrates the cross section taken along line VIIb-VIIb in FIG. 7(a). FIG. 7(c) illustrates the cross section taken along line VIIc-VIIc in FIG. 7(a).

As illustrated in FIG. 7, the battery 201 includes a power generating element 10, a first extraction electrode 220, a second extraction electrode 230, an insulating layer 140, and a spacer 250. The power generating element 10 is the same as those in the first and second embodiments, and description thereof is thus omitted. The insulating layer 140 is different in shape from that in the second embodiment but substantially the same as that in the second embodiment, and description thereof is thus omitted.

As illustrated in FIG. 7, the first extraction electrode 220 includes a first conductive member 121 and a first lead 22. The first conductive member 121 and the first lead 22 are the same as those in the second embodiment except the connection position of the first lead 22. As illustrated in FIG. 7(b), the first lead 22 is connected to the upper surface of the first conductive member 121. In other words, the first lead 22 is disposed on the opposite side of the first conductive member 121 from the power generating element 10.

The second extraction electrode 230 includes a second conductive member 231 and a second lead 32. The second conductive member 231 is different from the second conductive member 131 according to the second embodiment in the direction in which the second conductive member 231 projects from the power generating element 10 in plan view. Specifically, like the first conductive member 121, the second conductive member 231 projects from the power generating element 10 in the negative x-axis direction in plan view. In other words, in this embodiment, the first direction in which the first conductive member 121 projects is the same as the second direction in which the second conductive member 231 projects. In plan view, a region 231a of the second conductive member 231 that does not overlap the second current collector 15 overlaps a region 121a of the first conductive member 121 that does not overlap the first current collector 12. For example, the second conductive member 231 has the same shape and the same position as the first conductive member 121 in plan view.

The second lead 32 is the same as those in the first and second embodiments except the connection position and the extending direction. The second lead 32 is connected to the lower surface of the second conductive member 231. In other words, the second lead 32 is disposed on the opposite side of the second conductive member 231 from the power generating element 10. The second lead 32 is extended in the negative y-axis direction. In this embodiment, the extending direction of the second lead 32 is opposite to the extending direction of the first lead 22. This configuration can keep a distance between the second lead 32 and the first lead 22 and can suppress short-circuiting caused by contact between the leads.

In this embodiment, the spacer 250 is disposed between the region 121a of the first conductive member 121 and the region 231a of the second conductive member 231. The spacer 250 is an insulating member. For example, the spacer 250 is formed by using the same material as the insulating layer 140. In other words, the spacer 250 may contain the same material as the insulating layer 140. In FIG. 7(b), the spacer 250 is spaced apart from the insulating layer 140; however, the spacer 250 may be in contact with the insulating layer 140. In other words, the spacer 250 and the insulating layer 140 may be integrated. The spacer 250 can suppress short-circuiting caused by contact between the region 121a of the first conductive member 121 and the region 231a of the second conductive member 231.

The method for producing the battery 201 is the same as the method for producing the battery 101 according to the second embodiment illustrated in FIG. 6. The spacer 250 can be formed by the same process as the insulating layer 140. The battery 201 may not have the spacer 250.

### Fourth Embodiment

Next, a battery according to a fourth embodiment will be described. The fourth embodiment is different from the first to third embodiments mainly in the connection position of the second lead. Hereinafter, points different from the first to third embodiments will be mainly described, and description of common points is omitted or simplified.

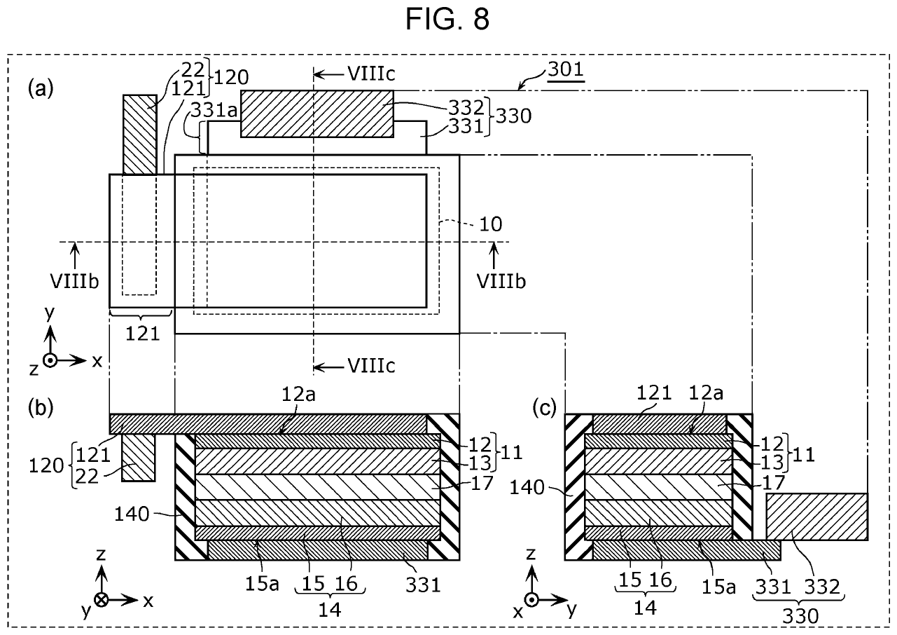

FIG. 8 illustrates a plan view and a cross-sectional view of a battery 301 according to this embodiment. Specifically, FIG. 8(a) is a plan view of the battery 301 as seen from the positive side of the z-axis. FIG. 8(b) illustrates the cross section taken along line VIIIb-VIIIb in FIG. 8(a). FIG. 8(c) illustrates the cross section taken along line VIIIc-VIIIc in FIG. 8(a).

As illustrated in FIG. 8, the battery 301 includes a power generating element 10, a first extraction electrode 120, a second extraction electrode 330, and an insulating layer 140. The power generating element 10 is the same as those in the first to third embodiments, and description thereof is thus omitted. The insulating layer 140 is different in shape from those in the second and third embodiments but substantially the same as those in the second and third embodiments, and description thereof is thus omitted.

As illustrated in FIG. 8, the second extraction electrode 330 includes a second conductive member 331 and a second lead 332. The second conductive member 331 is different from the second conductive member 131 according to the second embodiment in the direction in which the second conductive member 331 projects from the power generating element 10 in plan view. Specifically, the second conductive member 331 projects from the power generating element 10 in the positive y-axis direction in plan view. In other words, the second direction in which the second conductive member 331 projects is perpendicular to the first direction in which the first conductive member 121 projects. The projecting direction of the second conductive member 331 is the same as the extending direction of the first lead 22. The second conductive member 331 has a region 331a that does not overlap the second current collector 15. The second lead 332 is connected to the region 331a.

The second lead 332 is the same as the second lead 32 according to the first and second embodiments except the connection position and the extending direction. In the example illustrate in FIG. 8(a), the plan view shape of the second lead 332 is rectangular and elongated in the x-axis direction; however, the plan view shape of the second lead 332 is not limited to this. Like the first lead 22, the second lead 332 may be elongated in the y-axis direction. In this embodiment, the extending direction of the second lead 332 is the same as the extending direction of the first lead 22. Accordingly, the second lead 332 and the first lead 22 can be extended such that they are close to each other.

The projecting direction of the second conductive member 331 may be opposite to the extending direction of the first lead 22. In other words, the second conductive member 331 may project in the negative y-axis direction. In this case, the second lead 332 may extend in the negative y-axis direction or the positive or negative x-axis direction. The extending directions of the leads can be appropriately adjusted depending on an object on which the battery 301 is to be mounted. The battery 301 according to this embodiment has a high degree of freedom in the arrangement of the leads.

The method for producing the battery 301 is the same as the method for producing the battery 101 according to the second embodiment illustrated in FIG. 6.

### Fifth Embodiment

Next, a battery according to a fifth embodiment will be described. The fifth embodiment is different from the first to fourth embodiments mainly in that the first conductive member and the second conductive member are each connected to the corresponding current collector with an adhesive. Hereinafter, points different from the first to fourth embodiments will be mainly described, and description of common points is omitted or simplified.

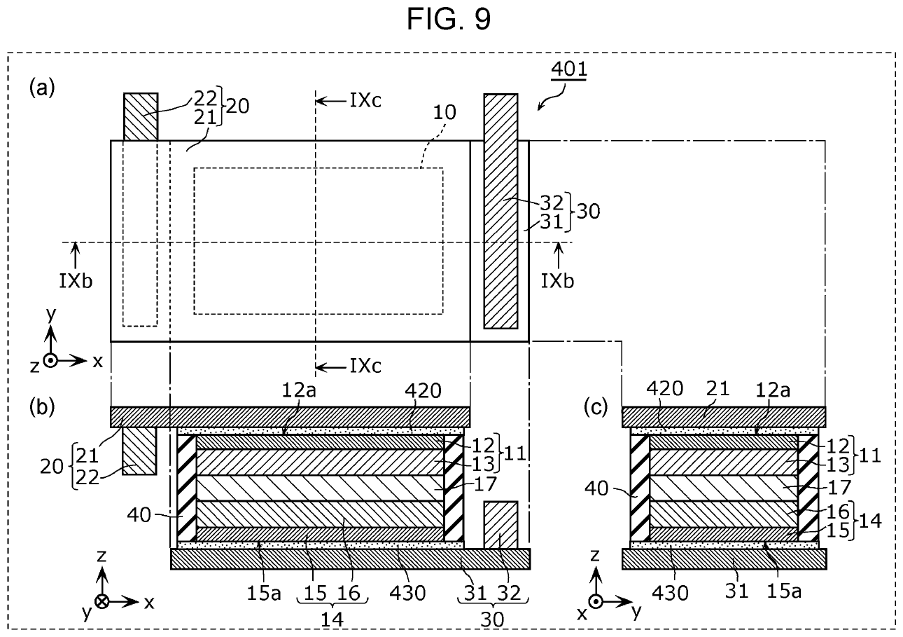

FIG. 9 illustrates a plan view and a cross-sectional view of a battery 401 according to this embodiment. Specifically, FIG. 9(a) is a plan view of the battery 401 as seen from the positive side of the z-axis. FIG. 9(b) illustrates the cross section taken along line IXb-IXb in FIG. 9(a). FIG. 9(c) illustrates the cross section taken along line IXc-IXc in FIG. 9(a).

As illustrated in FIG. 9, the battery 401 includes a power generating element 10, a first extraction electrode 20, a second extraction electrode 30, an insulating layer 40, an adhesive layer 420, and an adhesive layer 430. The power generating element 10, the first extraction electrode 20, the second extraction electrode 30, and the insulating layer 40 are the same as those in the first embodiment, and description thereof is thus omitted.

The adhesive layer 420 is located between the first current collector 12 and the first conductive member 21. The adhesive layer 420 bonds the main surface 12a of the first current collector 12 to the first conductive member 21. In other words, the first conductive member 21 is connected to the main surface 12a of the first current collector 12 through the adhesive layer 420.

The adhesive layer 420 covers the entire main surface 12a. As illustrated in FIGS. 9(b) and 9(c), the adhesive layer 420 also covers the upper surface of the insulating layer 40. The adhesive layer 420 may cover only the main surface 12a and may not cover the upper surface of the insulating layer 40. The adhesive layer 420 may cover only part of the main surface 12a.

The adhesive layer 420 has electrical conductivity. For example, the adhesive layer 420 is formed by using a conductive resin material. Alternatively, the adhesive layer 420 may be a solder layer. The adhesive layer 420 may be a carbon tape having electrical conductivity.

The adhesive layer 430 is located between the second current collector 15 and the second conductive member 31. The adhesive layer 430 bonds a main surface 15a of the second current collector 15 to the second conductive member 31. In other words, the second conductive member 31 is connected to the main surface 15a of the second current collector 15 through the adhesive layer 430.

The adhesive layer 430 covers the entire main surface 15a. As illustrated in FIGS. 9(b) and 9(c), the adhesive layer 430 also covers the lower surface of the insulating layer 40. The adhesive layer 430 may cover only the main surface 15a and may not cover the lower surface of the insulating layer 40. The adhesive layer 430 may cover only part of the main surface 15a.

The adhesive layer 430 has electrical conductivity. For example, the adhesive layer 430 is formed by using a conductive resin material. Alternatively, the adhesive layer 430 may be a solder layer. The adhesive layer 430 may be a carbon tape having electrical conductivity. The adhesive layer 430 may be formed of the same material as the adhesive layer 420 or may be formed of a different material from the adhesive layer 420.

In the battery 401 according to this embodiment, the bonding strength between the conductive members and the respective current collectors can be increased to prevent the conductive members and the leads from being detached from the power generating element 10. The reliability of the battery 401 can be improved accordingly.

The method for producing the battery 401 is the same as the method for producing the battery 1 according to the first embodiment illustrated in FIG. 4. In the step (S20) of performing connection of the first extraction electrode 20 and the second extraction electrode 30, the first current collector 12 and the first conductive member 21 are connected to each other after the adhesive layer 420 is formed on at least one of the main surface 12a of the first current collector 12 or the first conductive member 21. Similarly, the second current collector 15 and the second conductive member 31 are connected to each other after the adhesive layer 430 is formed on at least one of the main surface 15a of the second current collector 15 or the second conductive member 31.

The battery 401 may not have at least one of the adhesive layer 420 or 430. For example, one of the first extraction electrode 20 and the second extraction electrode 30 may be in contact with the first current collector 12 or the second current collector 15 and fixed to the first current collector 12 or the second current collector 15 under confining pressure, as in the first embodiment.

The battery 401 may include the first extraction electrode 120 instead of the first extraction electrode 20. The battery 401 may include the second extraction electrode 130, 230, or 330 instead of the second extraction electrode 30.

### Sixth Embodiment

Next, a battery according to a sixth embodiment will be described. The battery according to the sixth embodiment is different from the first to fifth embodiments in that the battery includes a plurality of power generating elements connected in series. Hereinafter, points different from the first to fifth embodiments will be mainly described, and description of common points is omitted or simplified.

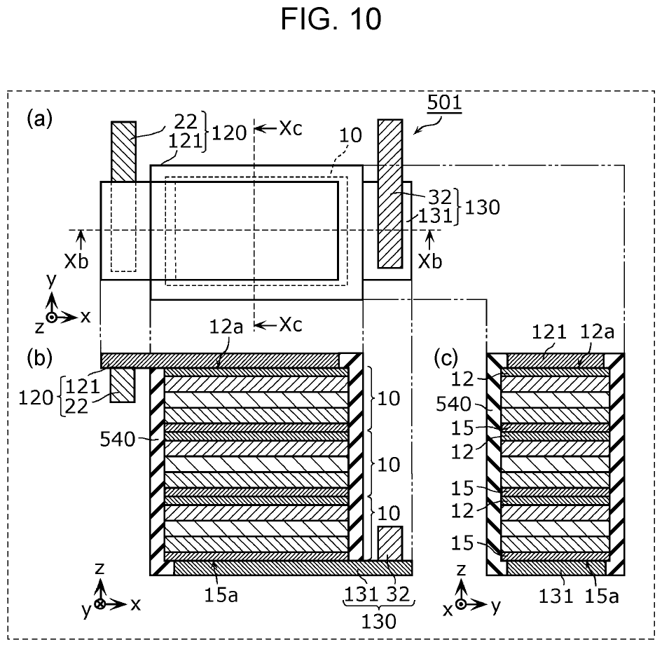

FIG. 10 illustrates a plan view and a cross-sectional view of a battery 501 according to this embodiment. Specifically, FIG. 10(a) is a plan view of the battery 501 as seen from the positive side of the z-axis. FIG. 10(b) illustrates the cross section taken along line Xb-Xb in FIG. 10(a). FIG. 10(c) illustrates the cross section taken along line Xc-Xc in FIG. 10(a).

As illustrated in FIG. 10, the battery 501 includes a plurality of power generating elements 10, a first extraction electrode 120, a second extraction electrode 130, and an insulating layer 540. The first extraction electrode 120 and the second extraction electrode 130 are the same as those in the second embodiment, and description thereof is thus omitted.

The plurality of power generating elements 10 are arranged in the thickness direction of the layers. In the example illustrated in FIG. 10, three power generating elements 10 are stacked in order. The number of power generating elements 10 stacked may be two or may be greater than or equal to four.

For example, among the plurality of power generating elements 10, the uppermost power generating element 10 is referred to as a first power generating element, and the middle power generating element 10 is referred to as a second power generating element. In this embodiment, a second electrode 14 of the first power generating element is connected to a first electrode 11 of the second power generating element. The first power generating element and the second power generating element are accordingly connected to each other in series.

In this embodiment, the plurality of power generating elements 10 are stacked in order such that the current collectors of the power generating elements 10 are in contact with each other so as to establish electrical series connection. Specifically, a positive electrode current collector of one power generating element 10 is connected to a negative electrode current collector of another power generating element 10. As illustrated in FIG. 10(c), the upper surface of the first current collector 12 of one power generating element 10 is in contact with the lower surface of the second current collector 15 of a power generating element 10 on the one power generating element 10. A member having electrical conductivity may be disposed between the upper surface of the first current collector 12 and the lower surface of the second current collector 15.

The first extraction electrode 120 is connected to the main surface 12a of the first current collector 12 of the uppermost power generating element 10 among the plurality of power generating elements 10. The second extraction electrode 130 is connected to the main surface 15a of the second current collector 15 of the lowermost power generating element 10 among the plurality of power generating elements 10.

Like the insulating layer 140 according to the second embodiment, the insulating layer 540 has a frame shape along the edge face of the power generating element 10. In this embodiment, the insulating layer 540 has a frame shape along the edge faces of the power generating elements 10. Furthermore, the insulating layer 540 covers an end portion of the main surface 12a of the first current collector 12 of the uppermost power generating element 10. The insulating layer 540 covers an end portion of the main surface 15a of the second current collector 15 of the lowermost power generating element 10.

Since the battery 501 according to this embodiment includes a plurality of the power generating elements 10 connected in series as described above, the extracted voltage is high, and the battery 501 has high reliability.

The method for producing the battery 501 is the same as the method for producing the battery 101 according to the second embodiment illustrated in FIG. 6. The power generating element 10 is formed (S10 to S14) multiple times in parallel or in sequence, and a plurality of the power generating elements 10 are then stacked on top of each other. The cutting step (S14) may be performed on the stacked power generating elements 10 at a time. The first extraction electrode 120 and the second extraction electrode 130 are connected to the power generating elements 10 (S20) after the power generating elements 10 are stacked and the outer peripheral portions thereof are cut out. The insulating layer 540 is then formed (S16) so as to cover the edge face of each of the power generating elements 10, and an outer peripheral portion of each of the upper surface of the uppermost power generating element 10 and the lower surface of the lowermost power generating element 10.

The battery 501 may include the first extraction electrode 20 instead of the first extraction electrode 120. The battery 501 may include the second extraction electrode 30, 230, or 330 instead of the second extraction electrode 130. The battery 501 may include at least one of the adhesive layer 420 or 430.

### Seventh Embodiment

Next, a battery according to a seventh embodiment will be described. The battery according to the seventh embodiment is different from the first to sixth embodiments in that the battery includes a plurality of power generating elements connected in parallel. Hereinafter, points different from the first to sixth embodiments will be mainly described, and description of common points is omitted or simplified.

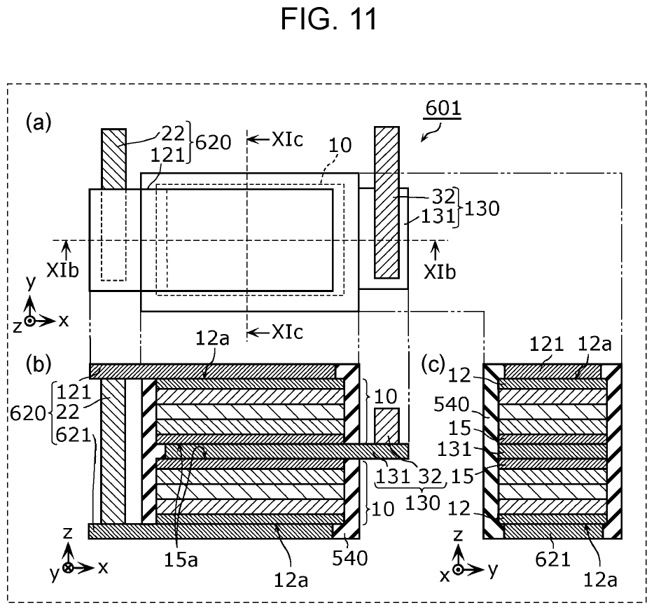

FIG. 11 illustrates a plan view and a cross-sectional view of a battery 601 according to this embodiment. Specifically, FIG. 11(a) is a plan view of the battery 601 as seen from the positive side of the z-axis. FIG. 11(b) illustrates the cross section taken along line XIb-XIb in FIG. 11(a). FIG. 11(c) illustrates the cross section taken along line XIc-XIc in FIG. 11(a).

As illustrated in FIG. 11, the battery 601 includes a plurality of power generating elements 10, a first extraction electrode 620, a second extraction electrode 130, and an insulating layer 540. The second extraction electrode 130 is the same as that in the second embodiment, and description thereof is thus omitted. The insulating layer 540 is different in shape from that in the sixth embodiment but substantially the same as that in the sixth embodiment, and description thereof is thus omitted.

The plurality of power generating elements 10 are arranged in the thickness direction of the layers. In the example illustrated in FIG. 11, two power generating elements 10 are stacked in order. The number of power generating elements 10 stacked may be greater than or equal to three.

For example, among the plurality of power generating elements 10, the upper power generating element 10 is referred to as a first power generating element, and the lower power generating element 10 is referred to as a second power generating element. In this embodiment, a second electrode 14 of the first power generating element is connected to a second electrode 14 of the second power generating element. The first power generating element and the second power generating element are accordingly connected to each other in parallel.

In this embodiment, the plurality of power generating elements 10 are stacked in order such that they are electrically connected to each other in parallel. Specifically, the positive electrode current collectors or negative electrode current collectors of the plurality of power generating elements 10 are connected to each other. For two power generating elements 10, the uppermost layer and the lowermost layer are electrodes having the same polarity. The first extraction electrode 620 includes two first conductive members 121 and 621, as illustrated in FIGS. 11(b) and 11(c).

Two first conductive members 121 and 621 are connected to the main surfaces 12a of the first current collectors 12 of two power generating elements 10. The main surface 12a of the first current collector 12 of the upper power generating element 10 is the upper surface, and the main surface 12a of the first current collector 12 of the lower power generating element 10 is the lower surface. Two first conductive members 121 and 621 project from the power generating element 10 in the negative x-axis direction in plan view. The first lead 22 is connected between two first conductive members 121 and 621. The first lead 22 may be connected only to the first conductive member 121, and the battery 601 may further include another first lead connected to the first conductive member 621. In other words, the battery 601 may include two first extraction electrodes 120.

The second extraction electrode 130 is connected to the second current collector 15 of each of two power generating elements 10. In other words, two second current collectors 15 are connected to the upper surface and the lower surface of the second conductive member 131 of the second extraction electrode 130.

Since the battery 601 according to this embodiment includes a plurality of the power generating elements 10 connected in parallel as described above, the battery 601 has a large capacity and high reliability.

The method for producing the battery 601 is the same as the method for producing the battery 101 according to the second embodiment illustrated in FIG. 6. Specifically, the power generating element 10 is formed (S10 to S14) multiple times in parallel or in sequence, and a plurality of the power generating elements 10 are then stacked on top of each other. At this time, two power generating elements 10 are stacked with the second extraction electrode 130 therebetween. Subsequently, the first extraction electrode 620 is connected (S20). The insulating layer 540 is then formed (S16) so as to cover the edge face of each of the plurality of the power generating elements 10, and an outer peripheral portion of each of the upper surface of the uppermost power generating element 10 and the lower surface of the lowermost power generating element 10.

The first extraction electrode 620 may include the first conductive member 21 instead of the first conductive members 121 and 621. The battery 601 may include the second extraction electrode 30, 230, or 330 instead of the second extraction electrode 130. The battery 601 may include at least one of the adhesive layer 420 or 430.

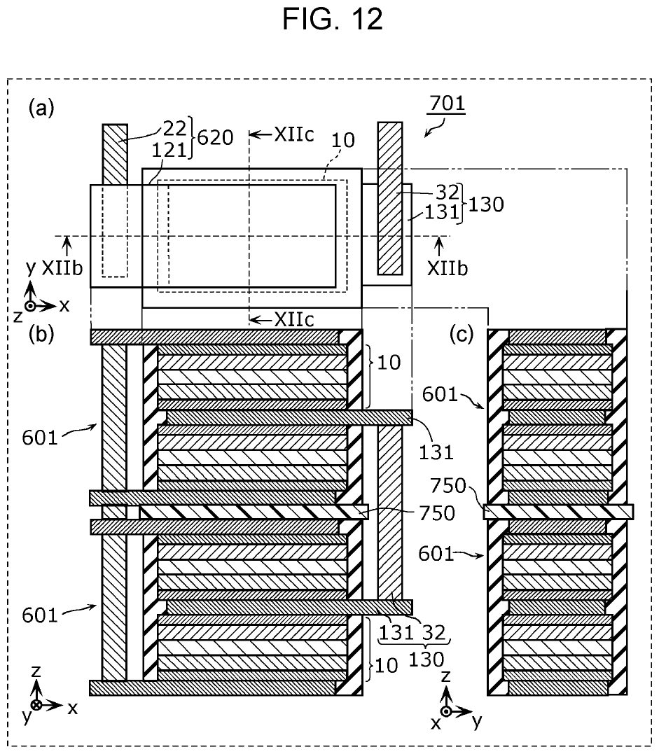

A plurality of the batteries 601 illustrated in FIG. 11 may be stacked on top of each other. FIG. 12 illustrates a plan view and a cross-sectional view of a battery 701 according to a modification of this embodiment. Specifically, FIG. 12(a) is a plan view of the battery 701 as seen from the positive side of the z-axis. FIG. 12(b) illustrates the cross section taken along line XIIb-XIIb in FIG. 12(a). FIG. 12(c) illustrates the cross section taken along line XIIc-XIIc in FIG. 12(a).

As illustrated in FIG. 12, the battery 701 has a multilayer structure including two batteries 601 illustrated in FIG. 11. Specifically, the battery 701 includes two batteries 601 and an insulating sheet 750. Two batteries 601 are stacked with the insulating sheet 750 therebetween.

The insulating sheet 750 is, for example, an insulating resin material and also functions as a buffer material. The stress generated in expansion caused by heat generation of the battery 701 can be reduced by the insulating sheet 750. The battery 701 may not have the insulating sheet 750.

In this modification, the second extraction electrodes 130 of two batteries 601 share one common second lead 32. In other words, two second extraction electrodes 130 have the same configuration as the first extraction electrode 620. Two second leads 32 may not be made common to two batteries 601.

As described above, the capacity of the battery 701 can be further increased.

### Modifications

Next, modifications of the above embodiments will be described. Specifically, modifications of the extraction electrodes will be described.

### Modification 1

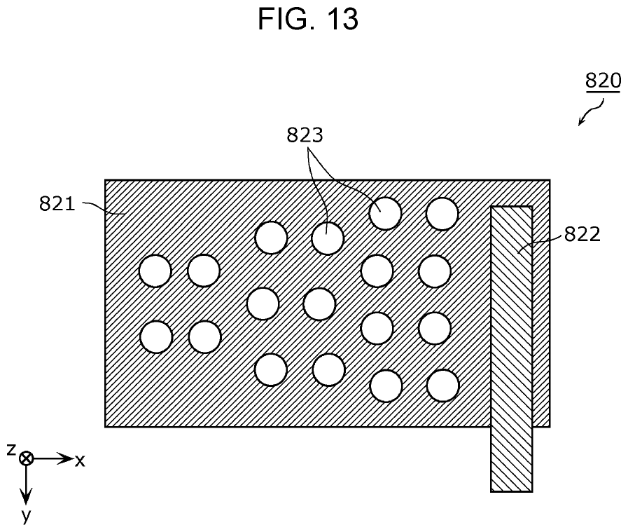

FIG. 13 is a plan view of an extraction electrode 820 according to Modification 1. The extraction electrode 820 can be used as at least one of the first extraction electrode or the second extraction electrode according to the embodiments described above.

As illustrated in FIG. 13, the extraction electrode 820 includes a conductive member 821 and a lead 822. The lead 822 is the same as the first lead 22 or the second lead 32 according to the first embodiment, and description thereof is thus omitted.

The conductive member 821 is different from the first conductive member and the second conductive member according to the embodiments in that the conductive member 821 is not uniform in sheet resistance. Specifically, the sheet resistance of the conductive member 821 decreases with distance from the lead 822. In this modification, the lead 822 is disposed in an end portion in the positive x-axis direction, and the sheet resistance of the conductive member 821 decreases in the negative x-axis direction.

Specifically, the conductive member 821 has a plurality of through-holes 823.

The sheet resistance of the conductive member 821 is controlled by at least one of the arrangement density or the opening area of the through-holes 823. The through-holes 823 illustrated in FIG. 13 have the same size and the same opening area. The arrangement density of the through-holes 823 decreases with distance from the lead 822. In other words, the number of through-holes 823 is large in a region near the lead 822, and the number of through-holes 823 is small in a region away from the lead 822. With this configuration, the sheet resistance is large in a region of the conductive member 821 near the lead 822, and the sheet resistance is small in a region away from the lead 822 of the conductive member 821. The through-holes 823 can be formed by punching holes in the conductive member 821 having a planar shape.

If the conductive member 821 is uniform in in-plane sheet resistance, the electric field tends to be concentrated in a region near the lead 822. In an area where the electric field is concentrated, degradation in power generating element tends to proceed.

In this modification, however, a large sheet resistance in a region near the lead 822 can suppress electric field concentration near the lead 822. This configuration can prevent or reduce local electric field concentration and can thus prevent or reduce local battery degradation. Therefore, the reliability of the battery can be improved.

The through-holes 823 may have different opening areas. For example, the opening areas of the through-holes 823 decrease with distance from the lead 822. The configuration in this case can also prevent or reduce local electric field concentration and can thus prevent or reduce local battery degradation. Therefore, the reliability of the battery can be improved.

### Modification 2

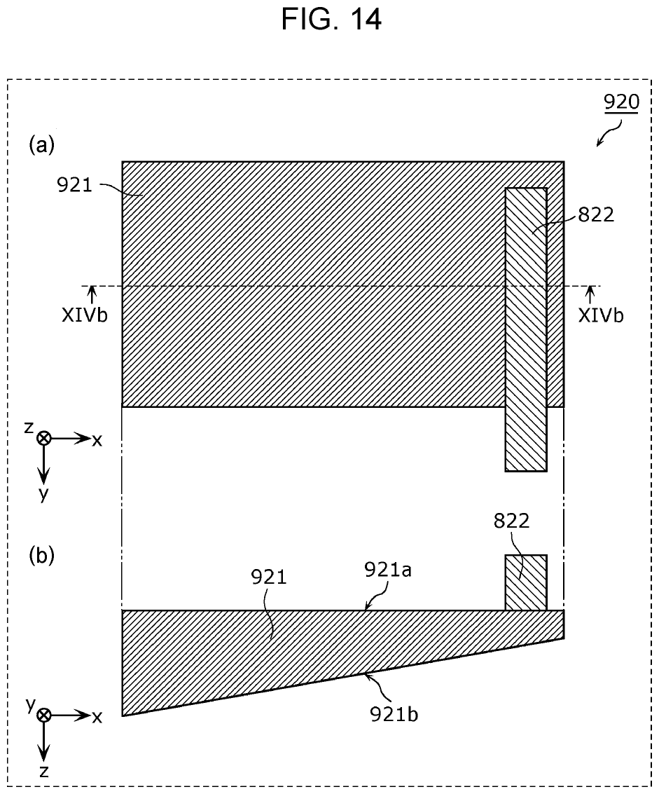

As illustrated in FIG. 14, the conductive member may have uneven thickness. FIG. 14 illustrates a plan view and a cross-sectional view of an extraction electrode 920 according to Modification 2. FIG. 14(a) is a plan view of the extraction electrode 920 as seen from the negative side of the z-axis. FIG. 14(b) illustrates the cross section taken along line XIVb-XIVb in FIG. 14(a).

As illustrated in FIG. 14, the extraction electrode 920 includes a conductive member 921 and a lead 822. The thickness of the conductive member 921 increases with distance from the lead 822 as illustrated in FIG. 14(b). The conductive member 921 has main surfaces 921a and 921b. The main surface 921a is a surface to be connected to a current collector. The main surface 921b is a surface opposite to the main surface 921a and slopes with respect to the main surface 921a. The thickness of the conductive member 921 smoothly changes according to the distance from the lead 822. The main surface 921a may be formed stepwise.

The sheet resistance of the conductive member 921 increases as the thickness of the conductive member 921 increases; and the sheet resistance decreases as the thickness decreases. This configuration can suppress local electric field concentration in the extraction electrode 920 illustrated in FIG. 14 and can thus suppress local battery degradation.

The conductive member 921 may have a plurality of through-holes 823.

### OTHER EMBODIMENTS

The batteries according to one or more aspects are described above on the basis of the embodiments, but the present disclosure is not limited to these embodiments. Various modifications of the embodiments that would be conceived by those skilled in the art, and forms constructed by combining components in different embodiments are also included in the present disclosure without departing from the gist of the present disclosure.

For example, the embodiments illustrate examples in which the extraction electrodes of both the positive electrode and the negative electrode of the battery each have a conductive member and a lead, but the battery may have only one of the extraction electrodes. In other words, the battery may not have a second extraction electrode including a second conductive member and a second lead. For example, the current collector in one of the positive electrode and the negative electrode of the battery may have the tab illustrated in FIG. 1 and FIG. 2, and the second lead may be directly connected to the tab. In this case, the required cutting accuracy is lower than that in the case where two current collectors both have a tab as illustrated in FIG. 1 and FIG. 2. This can improve the reliability of the battery.

Various modifications, substitutions, additions, omissions, and the like can be made to the embodiments described above within the scope of the claims or the range of their equivalency.

### INDUSTRIAL APPLICABILITY

The battery according to the present disclosure can be used as a secondary battery, such as an all-solid-state battery used in various electronic devices or automobiles.

What is claimed is:

1. A battery comprising:
a power generating element including a first electrode, a second electrode, and an electrolyte layer between the first electrode and the second electrode; and
a first extraction electrode,
wherein the first electrode includes:
a first current collector; and
a first active material layer between the first current collector and the electrolyte layer, and
the first extraction electrode includes:
a first conductive member connected to a first surface of the first current collector, the first surface being opposite to the first active material layer; and
a first lead connected to the first conductive member.

2. The battery according to claim 1, wherein
the first conductive member has a region that does not overlap the first current collector in plan view, and
the first lead is connected to the first conductive member in the region.

3. The battery according to claim 1, wherein the first conductive member is in contact with the first surface of the first current collector.

4. The battery according to claim 1, further comprising an adhesive layer between the first current collector and the first conductive member,
wherein the first conductive member is connected to the first surface of the first current collector through the adhesive layer.

5. The battery according to claim 4, wherein the adhesive layer has electrical conductivity.

6. The battery according to claim 1, wherein the first current collector and the first conductive member contain the same material.

7. The battery according to claim 1, wherein the conductive member has a thickness larger than or equal to a thickness of the first current collector.

8. The battery according to claim 1, further comprising an insulating layer having a frame shape along an edge face of the power generating element.

9. The battery according to claim 8, wherein the insulating layer further covers an end portion of the first surface of the first current collector.

10. The battery according to claim 1, wherein the first conductive member covers the entire first surface of the first current collector in plan view.

11. The battery according to claim 1, wherein a sheet resistance of the first conductive member decreases with distance from the first lead.

12. The battery according to claim 11, wherein
the first conductive member has a plurality of through-holes, and
at least one of an arrangement density or an opening area of the plurality of through-holes decreases with distance from the first lead.

13. The battery according to claim 11, wherein a thickness of the first conductive member increases with distance from the first lead.

14. The battery according to claim 1, further comprising a second extraction electrode,
wherein the second electrode includes:
a second current collector; and
a second active material layer between the second current collector and the electrolyte layer, and
the second extraction electrode includes:
a second conductive member connected to a second surface of the second current collector, the second surface being opposite to the second active material layer; and
a second lead connected to the second conductive member.

15. The battery according to claim 14, wherein
the first conductive member projects from the power generating element in a first direction in plan view,
the second conductive member projects from the power generating element in a second direction in plan view,
the first lead is connected to a projecting portion of the first conductive member, and
the second lead is connected to a projecting portion of the second conductive member.

16. The battery according to claim 15, wherein the first direction is opposite to the second direction.

17. The battery according to claim 15, wherein the first direction is the same as the second direction.

18. The battery according to claim 15, wherein the first direction is perpendicular to the second direction.

19. The battery according to claim 1, wherein the electrolyte layer contains a solid electrolyte having lithium-ion conductivity.

20. The battery according to claim 1, comprising a plurality of the power generating elements,
wherein the first extraction electrode is connected to the first current collector of a first power generating element that is one of the plurality of power generating elements, and
a second power generating element that is one of the plurality of power generating elements is disposed on a second electrode side of the first power generating element.

21. The battery according to claim 20, wherein the second electrode of the first power generating element is connected to the first electrode of the second power generating element.

22. The battery according to claim 20, wherein the second electrode of the first power generating element is connected to the second electrode of the second power generating element.
